(19) United States
(12) Patent Application Publication
(10) Pub. No.: US 2008/0239979 A1
(43) Pub. Date: Oct. 2, 2008

(54) Web service monitoring system using policy

(75) Inventors: Li-Der Chou, Jhongli City (TW); Cheien-Chi Chen, Jhongli City (TW); Yi-Ming Lin, Jhongli City (TW)

Correspondence Address: TROXELL LAW OFFICE PLLC, 5205 LEESBURG PIKE, SUITE 1404, FALLS CHURCH, VA, 22041, US

(73) Assignee: National Central University, Taoyuan County (TW)

(21) Appl. No.: 11/976,917

(22) Filed: Oct. 29, 2007

(30) Foreign Application Priority Data
Mar. 15, 2007 (TW) 096108868

(51) Int. Cl. G06F 11/00

(52) U.S. Cl. 370/252

(57) ABSTRACT

A system uses policy to monitor web services. A request of quality of service (QoS) is thus achieved. A control center monitors and manages service monitors to collect data from QoS units. A service level agreement (SLA) can be used with the policy for assigning tasks. The QoS request from a service requester can be thus fulfilled.

### FIELD OF THE INVENTION

The present invention relates to monitoring quality of service (QoS); more particularly, relates to managing service monitors and collecting QoS data of QoS units and to properly assigning monitoring tasks to the service monitors without over-loading.

### DESCRIPTION OF THE RELATED ART

Requests of network services grow day by day. Simple object access protocol (SOAP) and web services description language (WSDL) based on extensible markup language (XML) are used to describe the network services. However, network services are dynamic systems, having many unpredictable factors. So, it becomes crucial to maintain QoS of the network services, which comprises availability, reliability, security, etc.

As shown in FIG. 8, a prior art comprises a storage system 52, a control unit 522 and a storage media 524, where the storage system 52 is coupled to a fiber network system 51; and the fiber network system 51 comprises a plurality of virtual channels 512 to transfer a same kind of data per channel.

When an input/output (I/O) request is sent from a computer 53 in the fiber network system 51, the I/O request is transferred to the storage system 52 through the virtual channel 512 by the fiber network system 21 according to attributes and emergency of the requested data. After the I/O request is processed by the control unit 522, the requested data are accessed from the storage media 524.

When there are too many data of the same kind transferred at a time, those data are transferred by a default virtual channel 512 and thus bandwidth is not enough. On the contrary, when there are only few data transferred at a time, the bandwidth of the fiber network system 51 is not fully used and is thus wasted.

In a word, the prior art may form a congestion in a virtual channel owing to transferring too many data of the same kind at a time. Or, the other virtual channels may be wasted for only few data transferred at a time. Hence, the prior art does not fulfill all users' requests on actual use.

### SUMMARY OF THE INVENTION

The main purpose of the present invention is to manage service monitors and collect QoS data of QoS units.

An other purpose of the present invention is to setup policy according to an SLA and states of service monitors and to properly assign monitoring tasks to the service monitors without over-loading.

To achieve the above purposes, the present invention is a web service monitoring system using policy, comprising a service monitor control center, a plurality of service monitors and a plurality of QoS units, where the service monitor control center collects and monitors states of the service monitors; and monitoring tasks are assigned to the service monitors according to a service level agreement (SLA) and policies setup through an internal algorithm for effectively monitoring QoS data of the QoS units to achieve requests of a service requester. Accordingly, a novel web service monitoring system using policy is obtained.

### BRIEF DESCRIPTION OF THE DRAWINGS

The present invention will be better understood from the following detailed description of the preferred embodiment according to the present invention, taken in con junction with the accompanying drawings, in which

FIG. 1 is the view showing the structure of the preferred embodiment according to the present invention;

FIG. 2 is the view showing the state of the service monitor;

FIG. 3 is the view showing the policy management;

FIG. 4 is the view showing setting the policy;

FIG. 5 is the view showing the monitoring tasks;

FIG. 6 is the view showing the memory usage;

FIG. 7 is the view showing assigned tasks; and

FIG. 8 is the view of the prior art.

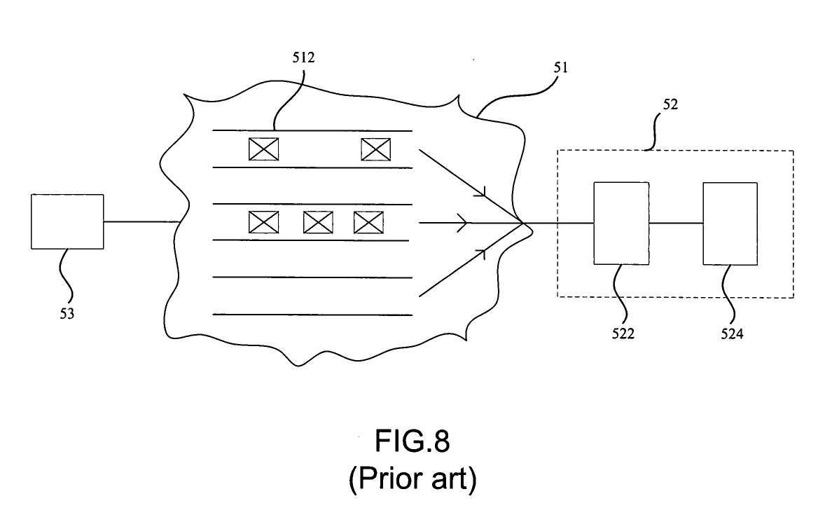

### DESCRIPTION OF THE PREFERRED EMBODIMENT

The following description of the preferred embodiment is provided to understand the features and the structures of the present invention.

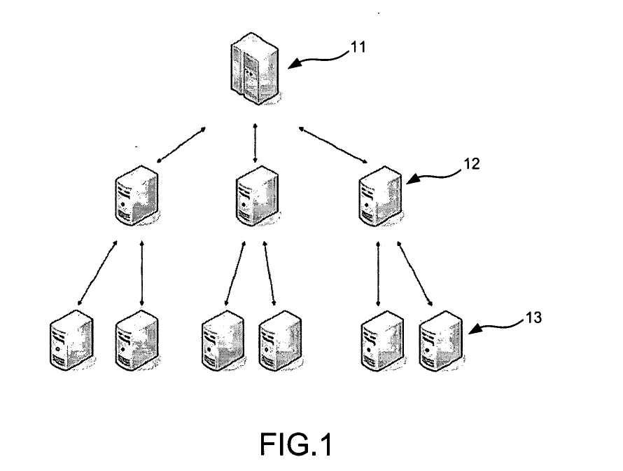

Please refer to FIG. 1, which is a view showing a structure of a preferred embodiment according to the present invention. As shown in the figure, the present invention is a we b service monitoring system using policy, comprising a service monitor control center 11, a plurality of service monitors 12 and a plurality of quality-of-service (QoS) units 13, where the service monitors 12 are managed altogether and real-time QoS data are collected by the service monitors 12.

The service monitor control center 11 distributes monitoring tasks to the service monitors 12.

The service monitors 12 are connected to the service monitor control center 11 for monitoring the QoS units 13.

The QoS units 13 are cataloged to be connected to the service monitors 12 and obtain QoS data.

On using the present invention, the service monitor control center 11 manages the service monitors 12; and the service monitors 12 monitor the QoS units 13 to collect data and evaluate a network service through interactions between a service requester and a service provider. A service level agreement (SLA) between the service requester and the service provider is used for service improvement. Thus, states of the service monitors 12 are collected and monitored by the service monitor control center 11. And monitoring tasks are assigned to the service monitors 12 according to the SLA and policies setup through an internal algorithm for effectively monitoring QoS data of the QoS units 13 to achieve requests of the service requester.

### Architecture of Service Monitor Control Center

The service monitor control center 11 is used to manage the service monitors 12 and to judge whether a service monitor 12 is busy or not according to a usage rate of central processing unit (CPU), a usage rate of memory and a monitored-object number. When the service requester wants to obtain QoS data, the service monitors 12 are used to help monitoring the QoS units 13 for obtaining data of a response time, availability, reliability, etc. In addition, the QoS units 13 are cataloged into the service monitors 12 to be monitored according to their services.

### Estimating a Response Time and a Time for Assigning a Task

The service monitors 12 respond task numbers and their states to the service monitor control center 11. If the response time is too long, the service monitor control center 11 may not obtain newest state and thus collect wrong data. If the response time is too short, the service monitor 12 may receives a new task added to an originally light loading and congestion may be formed owing to a sudden increased loading. Thus, a reasonable minimum response time is acquired for the service monitor control center 11 to neither receiving wrong data nor forming congestion with the following formula:

$${T}_{i} Ý \frac{{N}_{Update}}{{aB}_{total}} \qquad Formula ( 1 )$$

Therein, T is a time interval for returning data by the service monitor 12; Bₜₒₜₐₗ is a total bandwidth between the service monitor control center 11 and the service monitor 12; N_{update} is a packet size for each updating data; and αBₜₒₜₐₗ is a bandwidth for transmitting data, where 0≦a≦1.

From Formula (1), a minimum response time of T for returning data is obtained for the service monitor 12 according to the total bandwidth and the bandwidth for transmitting data. Thus, a best minimum response time of T is obtained by using an exponential weighted moving average (EWMA).

The service monitor control center 11 uses policy to manage the service monitors 12 and to assign tasks for effectively utilizing the service monitors 12. The policy is editable and yet-distributed monitoring tasks are managed. Policies are setup according to states affecting the service monitors 12. Up-boundaries and low-boundaries are setup for various service levels. For example, a policy is setup that, when a memory usage rate of a service monitor 12 is greater than 70%, a priority of assigning a new task is set to be a low value for the service monitor 12 and thus a new task is not assigned to the service monitor 12 next time. In this way, tasks are assigned according to states of the service monitors 12.

Besides, an SLA may be used. Factors affecting the QoS that the SLA describes has to be also considered. Such as, only a usage rate of memory of a service monitor, or a loading for a number of monitored objects, is monitored. A formula for assigning a task is as follows:

$${Q}^{j} ( t ) = {{{‡}^{”}}_{j = 1}}^{M} {W}_{i} {I}_{i}^{j} ( t ) , \\ {S}_{task} = min \{ {Q}^{j} ( t ) , {1}_{i} Ü {j}_{i} Ü R \} \qquad Formula ( 2 )$$

Therein, R is a monitored-object number; Sⱼ is the j^{th} service monitor; M is a number of service monitors and SLA factors; I₁^{j}(t) is a factor affecting the service monitor control center in time t; and Sₜₐₛₖ is a value for a service monitor receiving a task.

From Formula (2), it is known that, if the Sₜₐₛₖ has the smallest value, the service monitor has a smallest loading and thus has a priority for receiving a task. Yet, to avoid a time of assigning a task becoming too long or too short, a required time t is figured out for a policy through EWMA according to past or present monitoring records of the service monitor 12.

### Monitoring Area

Because the service monitor control center 11 may become unstable or rebooted, a backup server (not shown in the figure) is required. The backup server functions as the service monitor control center 11, and system states of the service monitor control center 11 are records. Once the service monitor control center 11 is shut or rebooted and the backup server do not receive system states of the service monitor control center 11 in a certain period of time, the backup server will take place of the service monitor control center 11 and announce a message to the service monitors 12 to demand the service monitors 12 to send data to the backup server. After the service monitor control center 11 is recovered, a message is sent to the service monitors 12 to demand the service monitors 12 to send data back to the original service monitor control center 11.

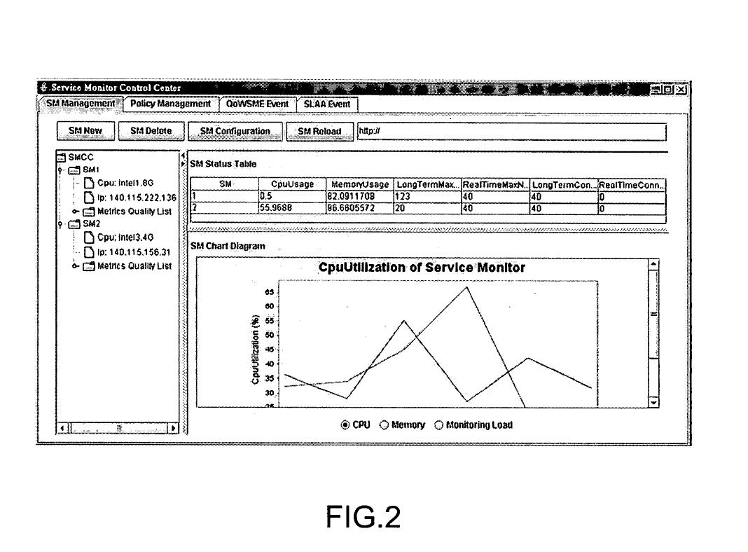

Please refer to FIG. 2 to FIG. 7, which are a view showing a state of a service monitor; a view showing a policy management; a view showing setting a policy; and views showing monitored tasks, memory usage and assigned tasks.

As shown in FIG. 2, a service monitor control center manages service monitors and assigning tasks through monitoring states of the service monitors according to policies. The service monitor control center shows states of CPU and memory and monitors loading through a usage rate of CPU, a usage rate of memory and a monitored-object number.

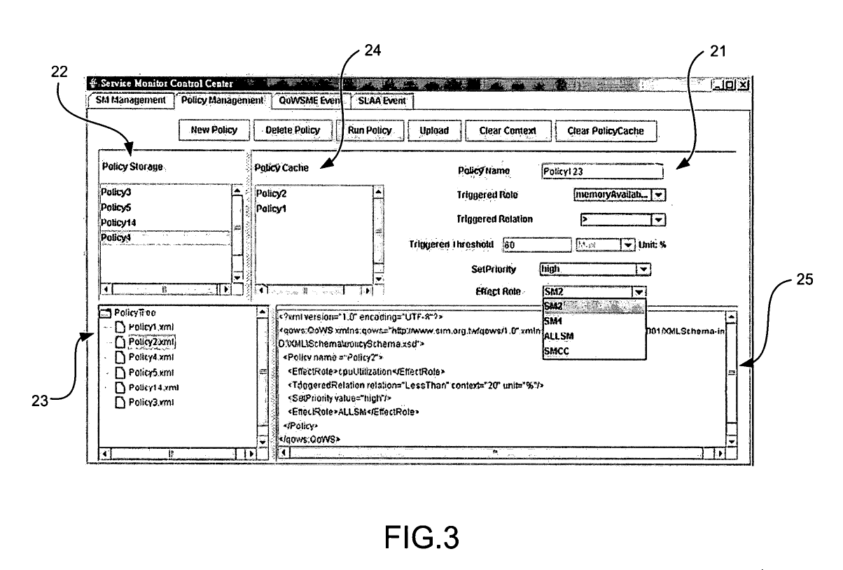

As shown in FIG. 3, a policy is setup to manage service monitors for assigning tasks. After a policy is edited in a policy panel 21, a New Policy button is pressed to show the new policy in a Policy Storage 22 and a PolicyTree 23. The policy is selectable in the PolicyTree 23; policies to be executed are shown in a Policy Cache 24; and, content of the policy is shown in an extended markup language (XML) area 25.

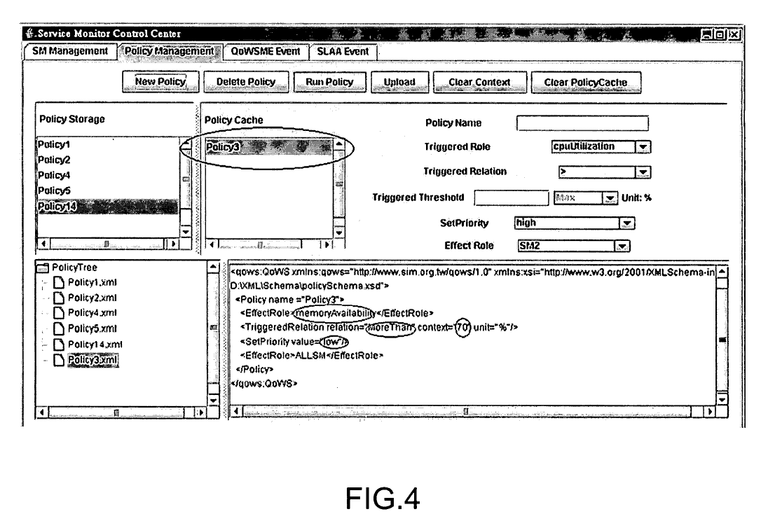

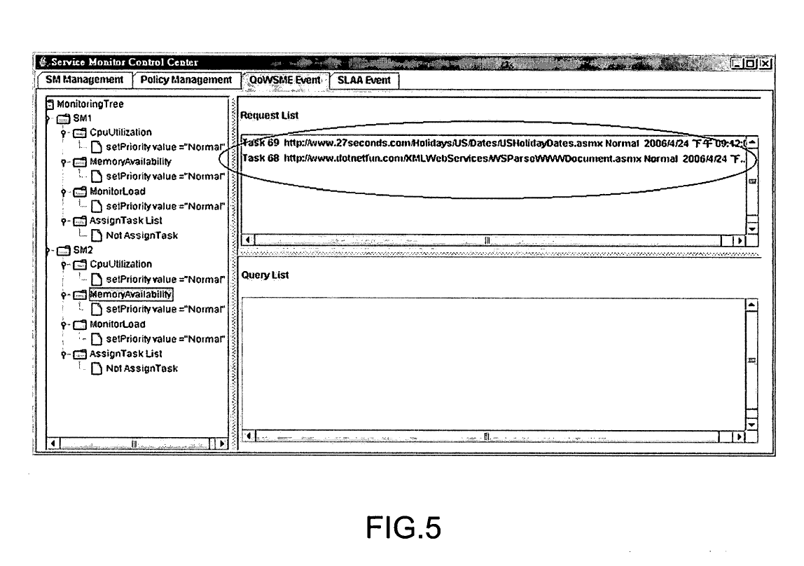

As shown in FIG. 4 and FIG. 5, Policy3 is selected that, when a memory usage rate of a service monitor 12 is greater than 70%, the service monitor 12 is set with a low priority. Tasks of two monitoring events, which are a request list and a query list, are included in a service request. The tasks are assigned to service monitors 12 by the service monitor control center for monitoring the service request. Therein the request list comprises a task ID, a monitored service, a related domain and an assigning time.

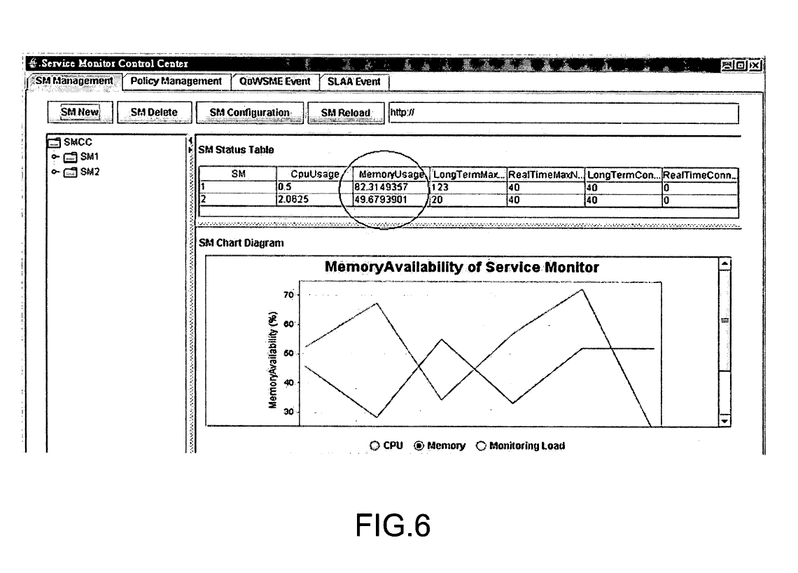

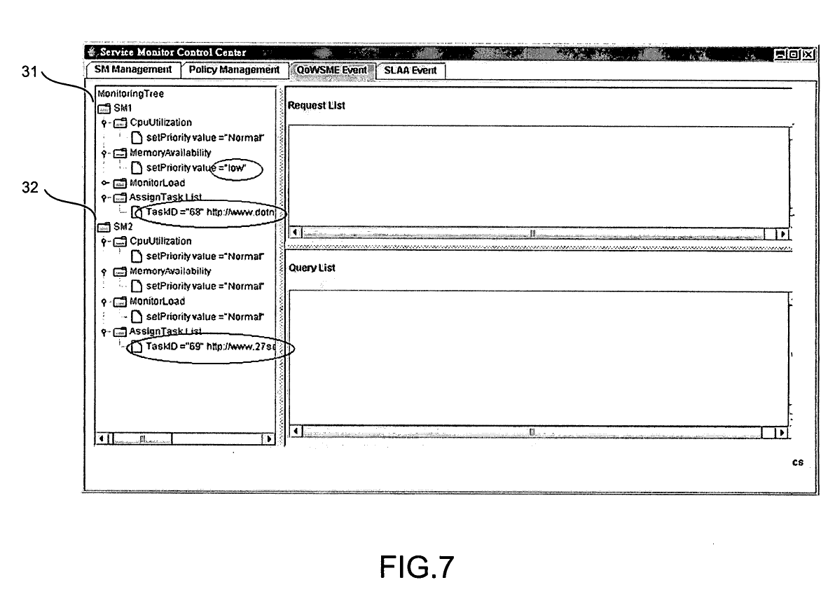

As shown in FIG. 6 and FIG. 7, a Java thread is used to acquire a state of a service monitor according to the above algorithm. On assigning a task, the state of the service monitor is monitored to see if a boundary is reached. Such as, according to Policy3, when a memory usage rate of a service monitor 12 is greater than 70%, the service monitor 12 is set with a low value for a priority of assigning a new task; and thus a new task is not assigned to the service monitor 12 next time. So, Task 69 is assigned to SM2 32, but not SM1 31. Besides, when a service requester requires a QoS from the service monitor, the service monitor control center responds.

To sum up, the present invention is a web service monitoring system using policy, where policy is setup according to an SLA and states of service monitors; and monitoring tasks are properly assigned to the service monitors without over-loading.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A web service monitoring system using policy, comprising:
a plurality of quality-of-service (QoS) units, said QoS unit obtaining QoS data;
a plurality of service monitors, said service monitors monitoring said QoS units; and
a service monitor control center, said service monitor control center distributing monitoring tasks to said service monitors.

2. The system according to claim 1,
wherein said QoS units are cataloged to be connected to said service monitors.

3. The system according to claim 1,
wherein said QoS data comprises a response time, availability and reliability.

4. The system according to claim 1,
wherein said service monitor control center obtains states of said service monitors, comprising a usage rate of central processing unit (CPU), a usage rate of memory and a monitored-object number.

5. The system according to claim 1,
wherein said service monitor control center distributes monitoring tasks according to policy.

6. The system according to claim 5,
wherein said policy is editable.

7. The system according to claim 1,
wherein said monitoring tasks are distributed according to policy based on a service level agreement (SLA) and states of said service monitors; and
wherein said monitoring tasks yet-distributed are managed.

8. The system according to claim 1,
wherein said service monitor monitors with an SLA and returns a response time through an exponential weighted moving average (EWMA).
